(19) United States
(12) Patent Application Publication
(10) Pub. No.: US 2008/0147886 A1
(43) Pub. Date: Jun. 19, 2008

(54) Methods and Systems for Providing Peripheral Device Services

(76) Inventor: Andrew Rodney Ferlitsch, Camas, WA (US)

Correspondence Address: KRIEGER INTELLECTUAL PROPERTY, INC., P.O. BOX 1073, CAMAS, WA, 98607, US

(21) Appl. No.: 11/611,044

(22) Filed: Dec. 14, 2006

(51) Int. Cl. G06F 3/00

(52) U.S. Cl. 710/1

(57) ABSTRACT

Embodiments of the present invention comprise systems and methods for providing peripheral device services requiring external sub-services.

### FIELD OF THE INVENTION

Embodiments of the present invention comprise methods and systems for providing peripheral device services requiring external sub-services.

### BACKGROUND

A user may directly submit digital data for output to a peripheral device from a client computing device. If the peripheral device itself does not support a process required to generate the user requested output, the peripheral device may find an external service to provide the requisite processing service. A portion of the processing required to generate the user requested output may be performed by an external service connected to the peripheral device.

The processing service may run on a dedicated server that may register (or broadcast) its processing capabilities with the peripheral device. The server may become overwhelmed, if it is simultaneously serving multiple clients. The server also may lack an application needed for a specific user's processing, while the required application may be available on the client computing device from which the output request originated. It may be desirable that clients advertise their applications as available to processing services.

### SUMMARY

Some embodiments of the present invention comprise methods and systems for providing a peripheral device service by requesting a sub-service from a client computing device.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a drawing showing embodiments of the present invention comprising at least one peripheral device; at least one client computing device and at least one external server;

FIG. 2 is a drawing sowing embodiments of the present invention comprising a peripheral device and a client computing device;

FIG. 3 is a flow diagram illustrating embodiments of the present invention in which a peripheral device may request a sub-service from a client computing device;

FIG. 4 is a flow diagram illustrating embodiments of the present invention in which a peripheral device may request a sub-service from a client computing device and may send data to the client computing device after pulling the data from the client computing device;

FIG. 5 is a flow diagram illustrating embodiments of the present invention in which a peripheral device may not send data to a client computing device, and the client computing device may obtain data locally to service a sub-service request;

FIG. 6 is a flow diagram illustrating embodiments of the present invention in which sub-services provided by a client computing device are private services;

FIG. 7 is a flow diagram illustrating embodiments of the present invention in which a client device pulls data from a peripheral device in completing a sub-service request;

FIG. 8 is a flow diagram illustrating embodiments of the present invention in which a client device accesses data locally in completing a sub-service request;

FIG. 9 is a drawing showing embodiments of the present invention comprising at least one imaging device; at least one client computing device and at least one external server;

FIG. 10 is a flow diagram illustrating embodiments of the present invention in which an imaging device may request a document rendering sub-service from a client computing device in order to complete a print service request;

FIG. 11 is a flow diagram illustrating embodiments of the present invention in which an imaging device may request a document rendering sub-service from an external service if the sub-service is not available from a client computing device;

FIG. 12 is a flow diagram illustrating embodiments of the present invention in which a client computing device may provide a sub-service to an imaging device if the sub-service is related to a service request originated from the client computing device;

FIG. 13 is a flow diagram illustrating embodiments of the present invention in which a client computing device may obtain a sub-service from an external server if the client computing device is unable to provide the sub-service;

FIG. 14 is a drawing showing embodiments of the present invention comprising at least one display device; at least one client computing device and at least one external server;

FIG. 15 is a flow diagram illustrating embodiments of the present invention in which a display device may request an A/V sub-service from a client computing device in order to complete a display service request;

FIG. 16 is a flow diagram illustrating embodiments of the present invention in which a display device may request an A/V sub-service from an external service if the sub-service is not available from a client computing device;

FIG. 17 is a flow diagram illustrating embodiments of the present invention in which a client computing device may provide a sub-service to a display device if the sub-service is related to a service request originated from the client computing device; and

FIG. 18 is a flow diagram illustrating embodiments of the present invention in which a client computing device may obtain a sub-service from an external server if the client computing device is unable to provide the sub-service.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Digital data may be submitted directly from a client computing device to a peripheral device for output. If the peripheral device itself does not support a process required to generate the requested output, the peripheral device may find an external service to provide the requisite processing service. A portion of the processing required to generate the requested output may be performed by an external service connected to the peripheral device.

The processing service may run on a dedicated server that may register or broadcast its processing capabilities with the peripheral device. The server may become overwhelmed, if it is simultaneously serving multiple clients. The server also may lack an application needed for a specific user's processing, while the required application may be available on the client computing device from which the output request originated.

Some embodiments of the present invention may comprise methods and systems for a client computing device to advertise its processing-related applications. In some embodiments of the present invention, a peripheral device may give preference to using a client computing device's available processing-related application over a server-based processing service when processing a job originating from the client computing device.

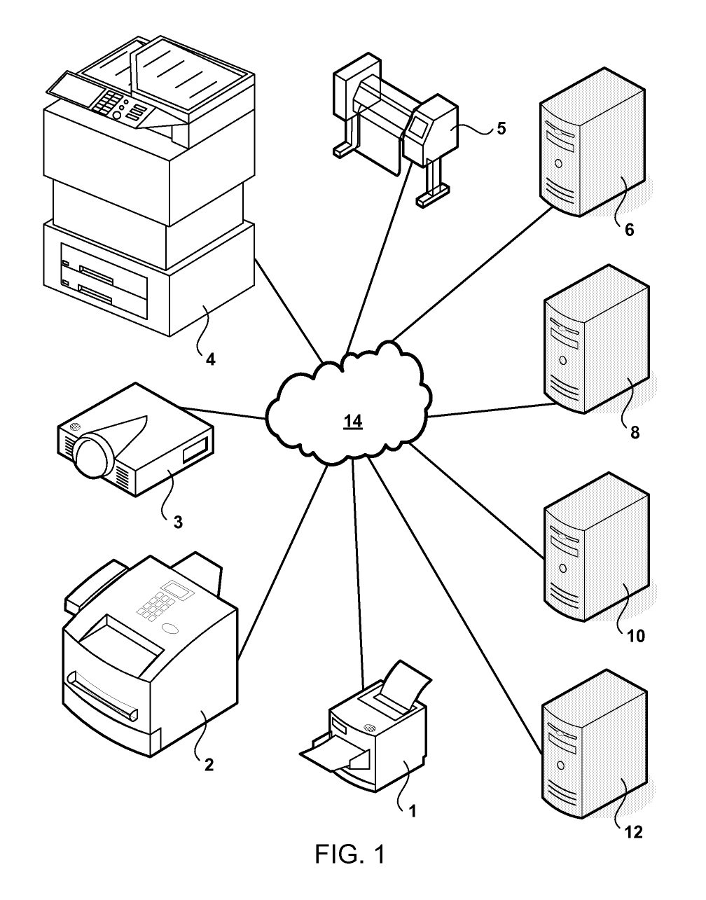

Exemplary embodiments of the present invention may be described in relation to FIG. 1. These exemplary embodiments may comprise one or more peripheral devices (five shown) 1-5 connected to one or more (two shown) client computing devices 6, 8 and one or more (two shown) external hosts or servers 10, 12. In some embodiments, a client computing device 6, 8 and a server 10, 12 may be distinct. In alternate embodiments, a client computing device 6, 8 and a server 10, 12 may be the same device.

In some embodiments of the present invention, the connection between a peripheral device 1-5 and a client computing device 6, 8 may be via a local port, for example, a USB (Universal Serial Bus) port, a serial port, a parallel port, and a SCSI (Small Computer System Interface). In alternate embodiments, the connection may be a network 14 connection using, for example, TCP/IP (Transmission Control Protocol/Internet Protocol) and AppleTalk. In alternate embodiments, the connection may be wireless connection using, for example, Wi-Fi® (Wireless Fidelity ®), Bluetooth®, and IRDA (Infrared Data Association).

In some embodiments of the present invention, the connection between a peripheral device 1-5 and a server 10, 12 may be via a local port, for example, a USB (Universal Serial Bus) port, a serial port, a parallel port, and a SCSI (Small Computer System Interface). In alternate embodiments, the connection may be a network 14 connection using, for example, TCP/IP (Transmission Control Protocol/Internet Protocol) and AppleTalk. In alternate embodiments, the connection may be wireless connection using, for example, Wi-Fi® (Wireless Fidelity ®), Bluetooth®, and IRDA (Infrared Data Association).

A peripheral device 1-5 may be capable of output operations of which exemplary output operations include printing, copying, faxing, inbound and outbound, scan-to-destination, format conversion, file transfer, filing, publishing, display, audio/video (A/V) recording and playback, A/V projection, compression/decoding, encryption/decryption, file input/output, natural language translation and other locale specific (client or peripheral, or both) services. In some embodiments of the present invention, an imaging device 2, 4 may advertise one or more of its output capabilities as a web service. In some embodiments of the present invention, a client computing device 6, 8 may advertise web services. In some embodiments of the present invention, a server 10, 12 may advertise web services.

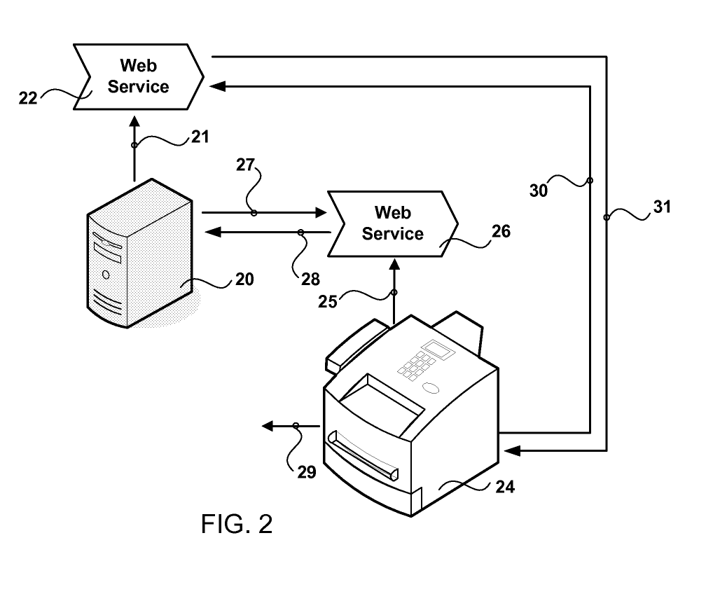

Exemplary embodiments of the present invention may be described in relation to FIG. 2. A client computing device 20 may advertise 21 a one or more web services 22 related to a processing service, and a peripheral device 24 may advertise 25 an output service 26 as a web service. The client computing device 20 may make an output request 27 of the peripheral device 24 via the advertised service 26. If the peripheral device 24, upon receipt of the request 27, determines that the request 27 may be wholly processed within the peripheral device 24, the peripheral device 24 may process the request 27, may inform 28 the client device 20 of the processing, and may generate the requested output 29. If the peripheral device 24 cannot handle the processing request 27, the peripheral device 24 may determine if the requesting client computing device 20 can provide a sub-service required to complete the processing request 27. If the client computing device 20 can provide the sub-service required to complete the processing request 27, the peripheral device 24 may send a job request 30 for the sub-service to the client computing device 20 via the advertised service 22. Upon fulfilling the job request 30 for the sub-service, the client computing device 20 may send the results 31 to the peripheral device 24. The peripheral device 24 may then complete the original request 27, and inform 28 the client device 20 of the processing and may generate the requested output 29.

In some embodiments, a service provided by the client computing device 20 may be a protected service and only available to complete a processing request originating from the client computing device 20. In alternative embodiments, a service provided by the client computing device 20 may be a public service and available to complete processing requests originating from any device. In yet alternative embodiments, a service provided by the client computing device 20 may be accessible only to complete a processing request originating from a limited group of devices, or may be accessible only if the service request is issued from the client computing device.

In embodiments in which the service provided by the client computing device 20 is protected, when the client computing device 20 receives a job request 30 for the sub-service required to complete the processing request 27, the client computing device 20 may verify that the job request 30 for the sub-service is being used to satisfy a processing request originating from the client computing device 20. An exemplary method by which this may be done is that the client computing device 20 may generate a unique identifier for each service request the client computing device 20 originates. In some embodiments, the unique identifier may expire once the service request is satisfied. Any request for a sub-service from a peripheral device may include the unique identifier provided by the originating client computing device. When the client computing device 20 receives a request from a peripheral device 24, the client computing device 20 may compare the identifier associated with the request with the identifiers associated with outstanding requests originating from the client computing device 24. If the identifier associated with the request matches the identifier for an outstanding request originating from the client computing device 24, the client computing device may provide the requested sub-services.

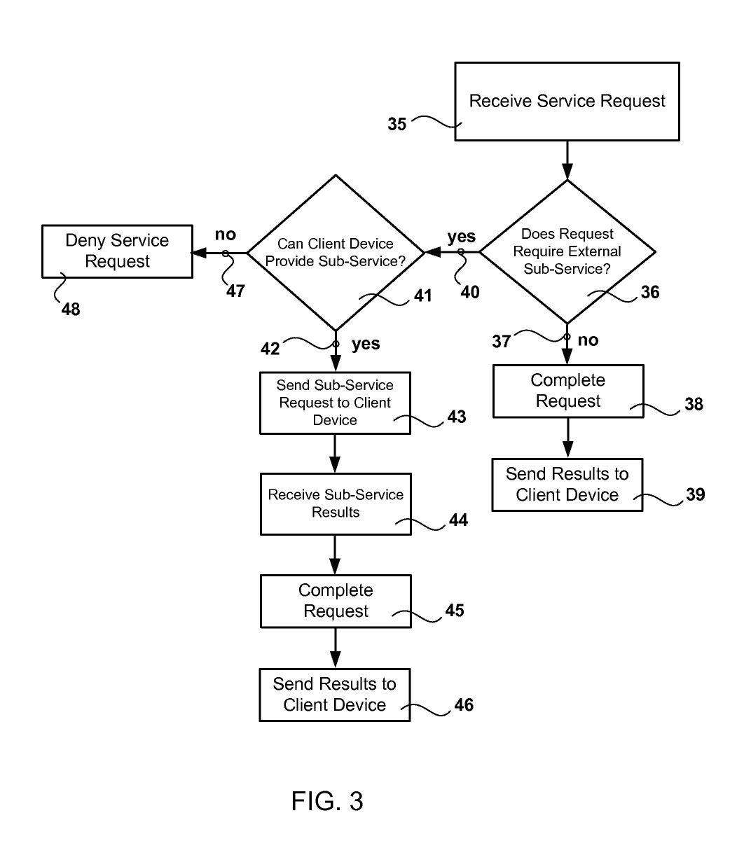

Embodiments of the present invention may be described in relation to FIG. 3. A service request may be received 35 at a peripheral device from a client computing device. The peripheral device may determine if an external sub-service is required in order to process the request 36. If the peripheral device can wholly process the request 37, then the peripheral device may process and complete the request 38 and send the results to the client computing device 39. If the peripheral device does not have all of the requisite services and applications to complete the client computing device request 40, then the peripheral device may determine if the client computing device can provide a sub-service required to complete the processing request 41. If the client computing device can provide a requisite sub-service 42, then the peripheral device may send a sub-service request to the client computing device 43. The peripheral device may then receive the sub-service results from the client computing device 44. The peripheral device may then complete the processing request 45 and send the results to the client computing device 46. If the peripheral device determines that the client computing device cannot provide a requisite sub-service 47, the peripheral device may deny the service request 48.

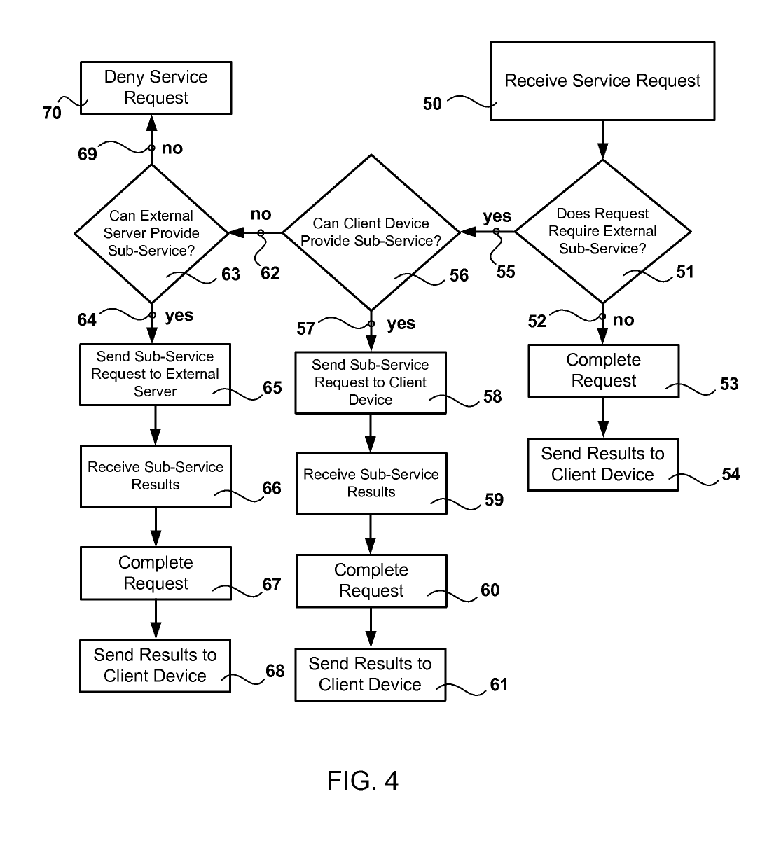

Alternate embodiments of the present invention may be described in relation to FIG. 4. A service request may be received 50 at a peripheral device from a client computing device. The peripheral device may determine if an external sub-service is required in order to process the request 51. If the peripheral device can wholly process the request 52, then the peripheral device may process and complete the request 53 and send the results to the client computing device 54. If the peripheral device does not have all of the requisite services and applications to complete the client computing device service request 55, then the peripheral device may determine if the client computing device can provide a sub-service required to complete the processing request 56. If the client computing device can provide a requisite sub-service 57, then the peripheral device may send a sub-service request to the client computing device 58. The peripheral device may then receive the sub-service results from the client computing device 59. The peripheral device may then complete the processing request 60 and send the results to the client computing device 61. If the peripheral device determines that the client computing device cannot provide a requisite sub-service 62, then the peripheral device may determine if an external server can provide a sub-service required to complete the processing request 63. If the external server can provide the sub-service 64, then the peripheral device may send a sub-service request to the external server 65. The peripheral device may receive the sub-service results from the external server 66, and then the peripheral device may complete the service request 67. Upon completion of the service request, the peripheral device may send the results to the client computing device 68. If the peripheral device determines that an external server cannot provide the sub-service 69, then the peripheral device may deny the service request 70.

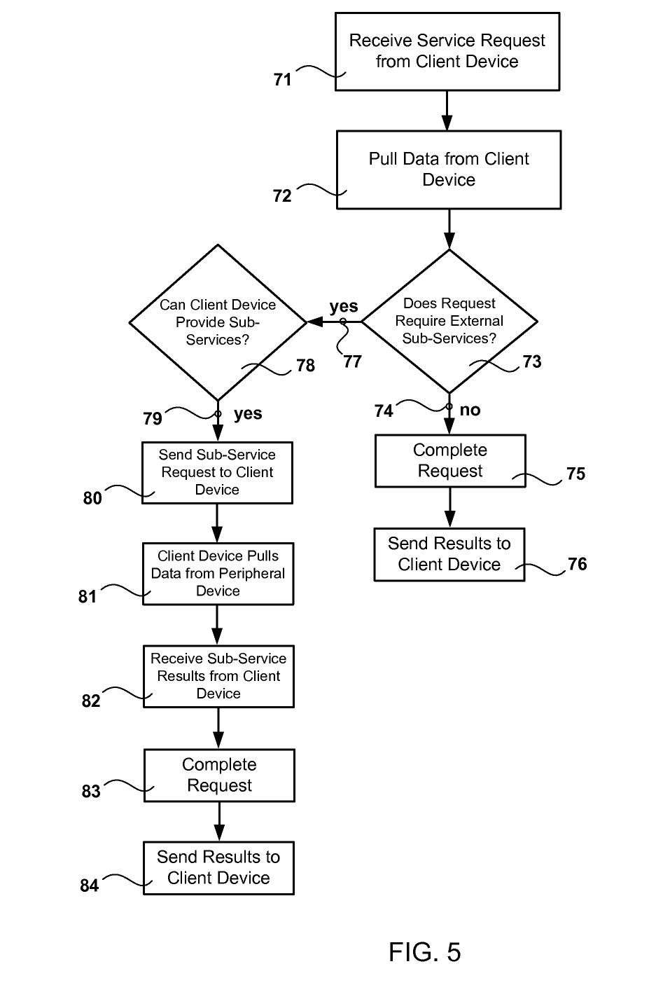

Some embodiments of the present invention may be described in relation to FIG. 5. In these embodiments, a peripheral device may receive a service request 71 from a client computing device. The peripheral device may then pull the data to process 72 from the client computing device. The peripheral device may then determine an external sub-service is required to fulfill the processing request 73. If the peripheral device can wholly process the request 74, the peripheral device may complete the request 75 and send results 76 to the client computing device. If the peripheral device requires an external sub-service 77 to complete the request, then the peripheral device may determine if the client computing device can provide a required sub-service 78. If the client computing device can provide a required sub-service 79, then the peripheral device may send a sub-service request to the client computing device 80. The client computing device may pull the data to process from the peripheral device 81. The peripheral device may receive the sub-service results from the client computing device 82 and then complete the service request 83. The peripheral device may then send the results to the client computing device 84. In alternate embodiments, if the peripheral device determines that the client computing device cannot provide a required sub-service, then the peripheral device may deny the service request.

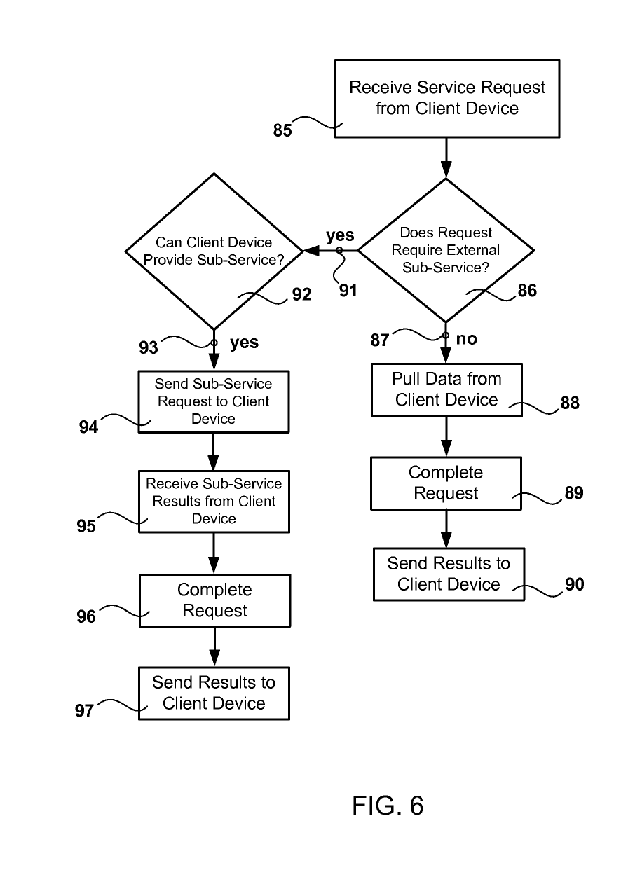

Alternate embodiments of the present invention may be described in relation to FIG. 6. In these embodiments, a peripheral device may receive a service request 85 from a client computing device. The peripheral device may then determine if an external sub-service is required to fulfill the processing request 86. If the peripheral device can wholly process the request 87, the peripheral device may then pull the data to process 88 from the client computing device. The peripheral device may complete the request 89 and may send results 90 to the client computing device. If the peripheral device requires an external sub-service 91 to complete the request, then the peripheral device may determine if the client computing device can provide a required sub-service 92. If the client computing device can provide a required sub-service 93, then the peripheral device may send a sub-service request to the client computing device 94. The client computing device may process the data which may still reside on the client computing device and send the processed data to the peripheral device in order that the peripheral device may complete the service request. The peripheral device may receive the sub-service results from the client computing device 95 and then complete the service request 96. The peripheral device may then send the results to the client computing device 97. In alternate embodiments, if the peripheral device determines that the client computing device cannot provide a required sub-service, then the peripheral device may deny the service request.

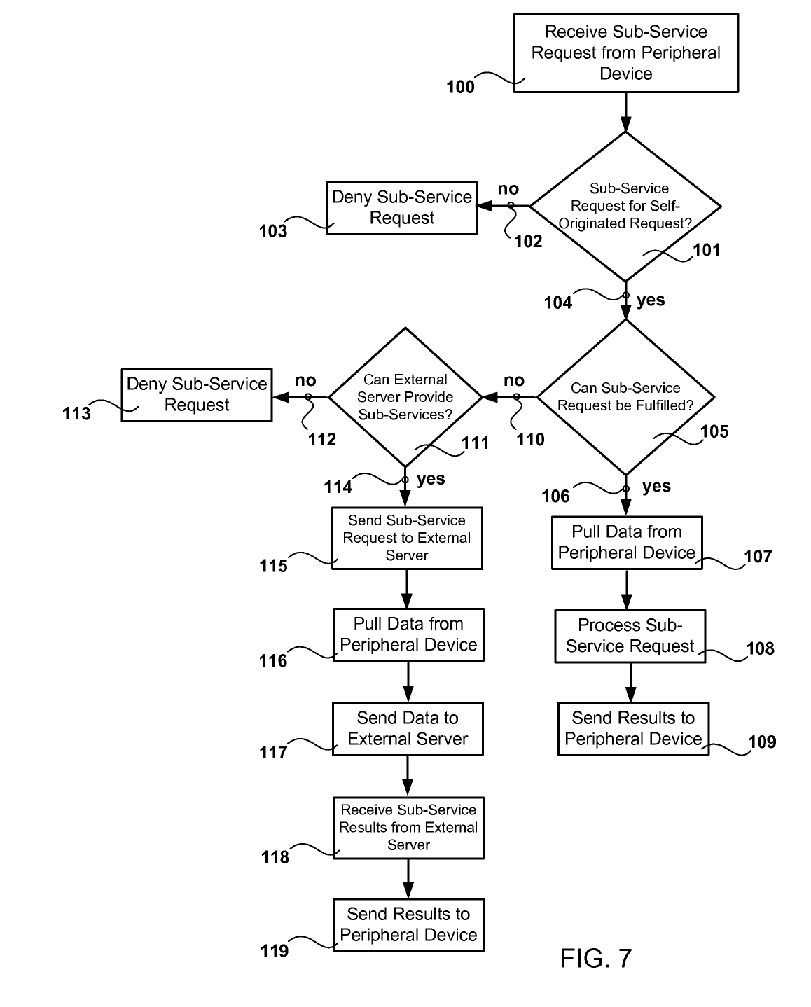

Some embodiments of the present invention may be described in relation to FIG. 7. In these embodiments, a client computing device may receive a sub-service processing request from a peripheral device 100. The client computing device may determine if the request is related to a processing request that originated from the client computing device 101. If the sub-service request is not for a request that originated from the client computing device 102, the client computing device may refuse or otherwise deny the sub-service request 103. If the sub-service request is for a processing request that originated from the client computing device 104, the client computing device may determine if it can fulfill the request 105. If the client computing device can fulfill the request 106, the client computing device may pull the data to process from the peripheral device 107 and may provide the sub-service 108, sending the results to the peripheral device 109. If the sub-service request cannot be fulfilled 110 by the client computing device, the client computing device may determine if an external server can provide the sub-service 111. If the client computing device cannot locate or otherwise determine an external server capable of providing the requested sub-service 112, the client computing device may refuse or otherwise deny the sub-service request 113. If the client computing device can locate or otherwise determine an external server capable of providing the requested sub-service 114, the client computing device may send a sub-service request to the external server 115. The client computing device may pull the data from the peripheral device 116 and may forward the data to the external server 117. The client computing device may receive the sub-service results from the external server 118 and then may send the results to the peripheral device 119. In alternate embodiments, if the client computing device determines it cannot provide the sub-service, then it may refuse or otherwise deny the sub-service request without attempting to locate an external server capable of providing the requisite sub-service.

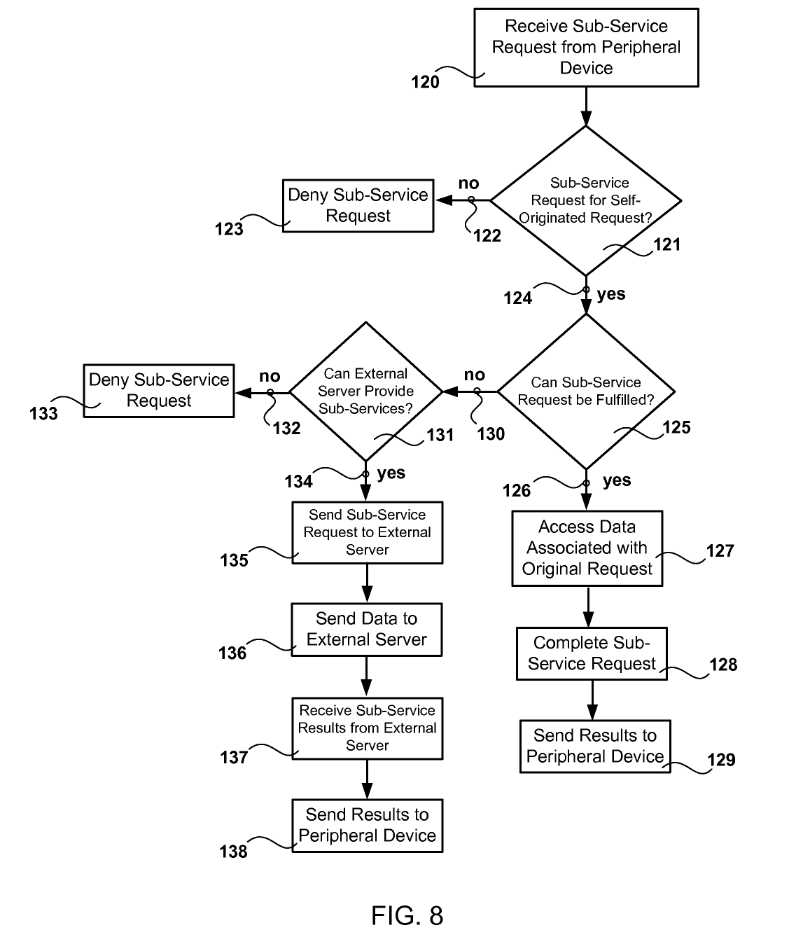

Some embodiments of the present invention may be described in relation to FIG. 8. In these embodiments, a client computing device may receive a sub-service processing request from a peripheral device 120. The client computing device may determine if the request is related to a processing request that originated from the client computing device 121. If the sub-service request is not for a request that originated from the client computing device 122, the client computing device may refuse or otherwise deny the sub-service request 123. If the sub-service request is for a processing request that originated from the client computing device 124, the client computing device may determine if it can fulfill the request 125. If the client computing device can fulfill the request 126, the client computing device may access locally the data to process 127 and may provide the sub-service 128, sending the results to the peripheral device 129. If the sub-service request cannot be fulfilled 130 by the client computing device, the client computing device may determine if an external server can provide the sub-service 131. If the client computing device cannot locate or otherwise determine an external server capable of providing the requested sub-service 132, the client computing device may refuse or otherwise deny the sub-service request 133. If the client computing device can locate or otherwise determine an external server capable of providing the requested sub-service 134, the client computing device may send a sub-service request to the external server 135. The client computing device may forward the data to the external server 136. The client computing device may receive the sub-service results from the external server 137 and then may send the results to the peripheral device 138. In alternate embodiments, if the client computing device determines it cannot provide the sub-service, then it may refuse or otherwise deny the sub-service request without attempting to locate an external server capable of providing the requisite sub-service.

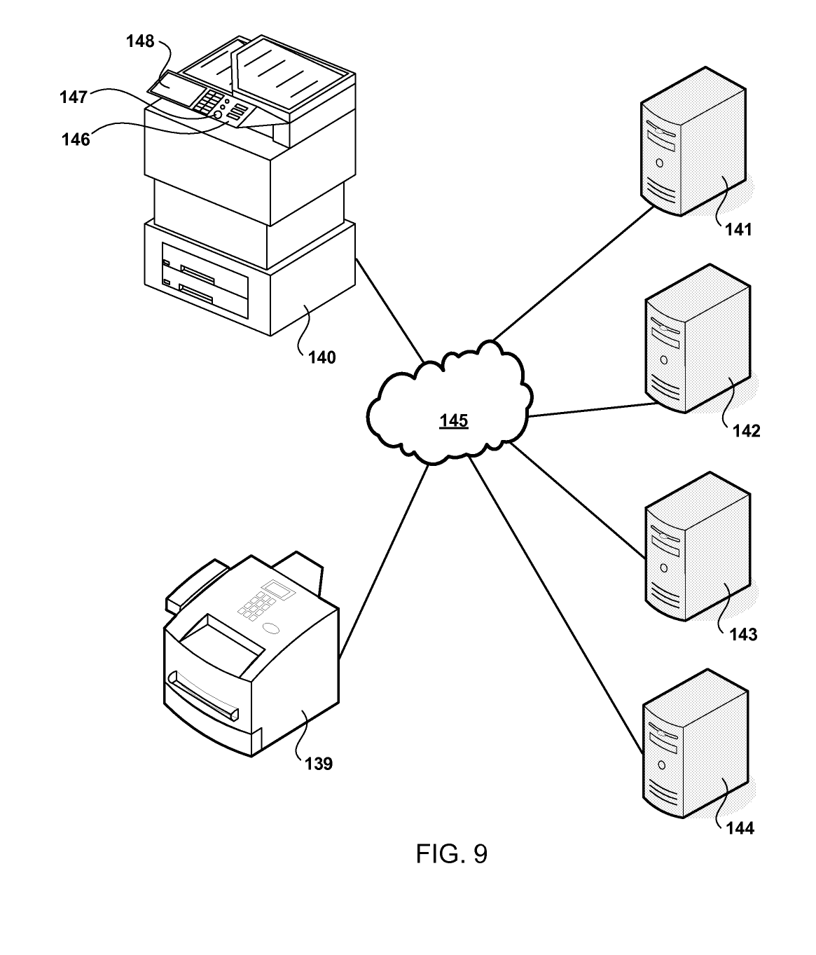

Exemplary embodiments of the present invention may be described in relation to FIG. 9. These exemplary embodiments may comprise one or more imaging devices (two shown) 139, 140. In some embodiments, an imaging device 139, 140 may take the form of a multi-function peripheral device (MFP) that combines the functions of two or more traditionally separated imaging devices. An MFP may combine any number of imaging devices, but typically comprises the functions of a printer, scanner, copier and fax machine. In alternate embodiments, an imaging device 139, 140 may take the form of a separate printer, scanner, copier, fax machine, or other separated imaging device.

An imaging device 139, 140 may be connected to one or more (two shown) client computing devices 141, 142 and one or more (two shown) external hosts or servers 143, 144. In some embodiments, a client computing device 141, 142 and a server 143, 144 may be distinct. In alternate embodiments, a client computing device 141, 142 and a server 143, 144 may be the same device.

In some embodiments of the present invention, the connection between an imaging device 139, 140 and a client computing device 141, 142 may be via a local port, for example, a USB (Universal Serial Bus) port, a serial port, a parallel port, and a SCSI (Small Computer System Interface). In alternate embodiments, the connection may be a network 145 connection using, for example, TCP/IP (Transmission Control Protocol/Internet Protocol) and AppleTalk. In alternate embodiments, the connection may be wireless connection using, for example, Wi-Fi® (Wireless Fidelity®, Bluetooth®, and IRDA (Infrared Data Association).

In some embodiments of the present invention, the connection between an imaging device 139, 140 and a server 143, 144 may be via a local port, for example, a USB (Universal Serial Bus) port, a serial port, a parallel port, and a SCSI (Small Computer System Interface). In alternate embodiments, the connection may be a network 145 connection using, for example, TCP/IP (Transmission Control Protocol/Internet Protocol) and AppleTalk. In alternate embodiments, the connection may be wireless connection using, for example, Wi-Fi® (Wireless Fidelity®, Bluetooth®, and IRDA (Infrared Data Association).

An imaging device 140 may further comprise a user interface (UI) panel 146, which may comprise input buttons 147 and a display device 148. In some embodiments, the display device 148 may comprise a touch panel system with or without input buttons 147.

An imaging device 139, 140 may be capable of output operations of which exemplary output operations include printing, copying, faxing, inbound and outbound, scan-to-destination, format conversion, file transfer, filing, publishing, display, and audio/video (A/V) recording and playback.

In some embodiments of the present invention, an imaging device 139, 140 may advertise one or more of its output capabilities as a web service. In some embodiments of the present invention, a client computing device 141, 142 may advertise web services. A client computing device 141, 142 may advertise a one or more web services related to document rendering. Exemplary services may include document format conversion, natural language translation and document rendering services. In some embodiments of the present invention, a server 143, 144 may advertise web services. Exemplary server-based services may include document format conversion, natural language translation and document rendering services.

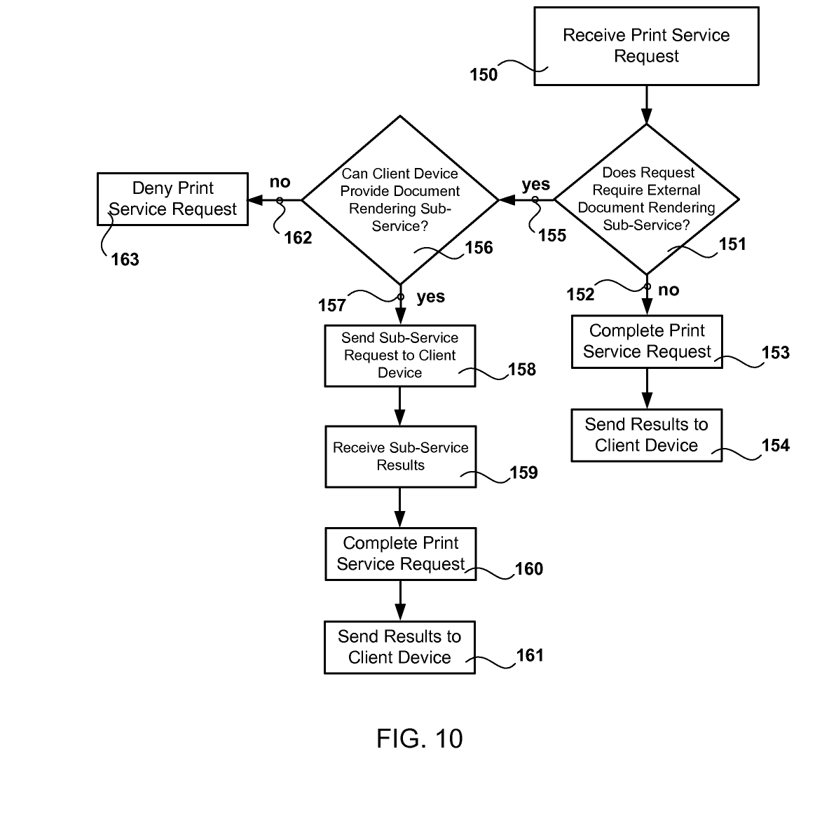

In some exemplary embodiments described in relation to FIG. 10, a client computing device may originate a print service request for a document in its native format to the advertised print web service of an imaging device. Upon receipt of the print service request 150, the imaging device may determine if the print service request can be wholly completed internally within the imaging device 151. One exemplary element of this determination may be a determination of whether or not the imaging device can provide the print service for a document in the native format sent by the client computing device. If the imaging device can complete the print service request without external services 152, the imaging device may complete the print service request 153, generating a printed document and sending service results to the client computing device 154. If the imaging device determines that it cannot wholly complete the print service request 155, for example, if the imaging device cannot handle the print service request natively, the imaging device may attempt to determine if the originating client computing device can provide the format conversion sub-service required to complete the print service request 156. If the client computing device can provide the format conversion sub-service 157, then the imaging device may make a sub-service request of the client computing device 158 for the format conversion sub-service. The client computing device may provide the format conversion sub-service and return the converted document data to the imaging device. The imaging device may receive the sub-service results 159, and the imaging device may then use the sub-service results (the converted document data) to complete the service request 160 of the originating client computing device and return the results to the originating client computing device 161. If the imaging device determines that the client computing device cannot provide the requisite sub-service 162, the imaging device may refuse or otherwise deny the print service request 163.

In some embodiments of these exemplary embodiments of the present invention, the format conversion sub-service provided by the client computing device may be a public service available to any device. In alternate embodiments, the format conversion sub-service provided by the client computing device may be available to a limited group of devices. In yet alternate embodiments, the format conversion sub-service provided by the client computing device may be a protected service that may only be available to fulfill a service request that originated from the client computing device. In yet alternate embodiments, the format conversion sub-service provided by the client computing device may be a private service that may only be available to fulfill a service request from within the client computing device. In these yet alternative embodiments, the client computing device, upon receipt of a request for a format conversion sub-service, may ascertain if the sub-service request is a request generated in order to fulfill a service request originated by the client computing device.

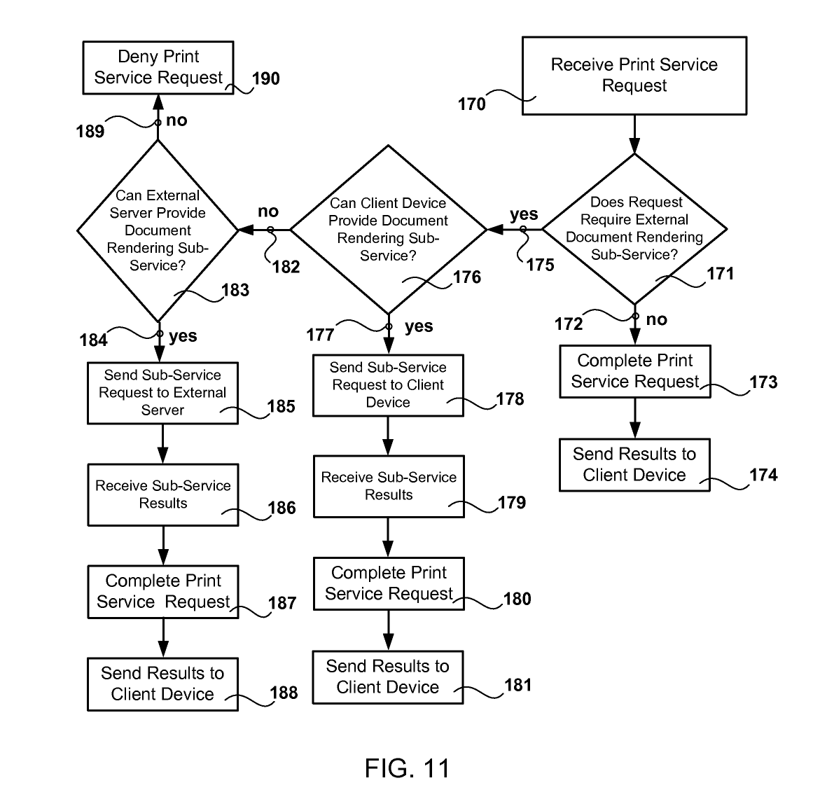

Alternate embodiments of the present invention may be described in relation to FIG. 11. A print service request may be received 170 at an imaging device from a client computing device. The imaging device may determine if an external sub-service is required in order to process the print service request 171. If the imaging device can wholly complete the print service request 172, then the imaging device may process and complete the request 173 and send the results to the client computing device 174. If the imaging device does not have all of the requisite services and applications (e.g., format conversion applications) to complete the client computing device print service request 175, then the imaging device may determine if the client computing device can provide a sub-service required to complete the print service request 176. If the client computing device can provide a requisite sub-service 177, then the imaging device may send a sub-service request to the client computing device 178. The imaging device may then receive the sub-service results from the client computing device 179. The imaging device may then complete the print service request 180 and send the results to the client computing device 181. If the imaging device determines that the client computing device cannot provide a requisite sub-service 182, then the imaging device may determine if an external server can provide a sub-service required to complete the print service request 183. If the external server can provide the sub-service 184, then the imaging device may send a sub-service request to the external server 185. The imaging device may receive the sub-service results from the external server 186, and then the imaging device may complete the print service request 187. Upon completion of the print service request, the imaging device may send the results to the client computing device 188. If the imaging device determines that an external server cannot provide the sub-service 189, then the imaging device may refuse or otherwise deny the print service request 190.

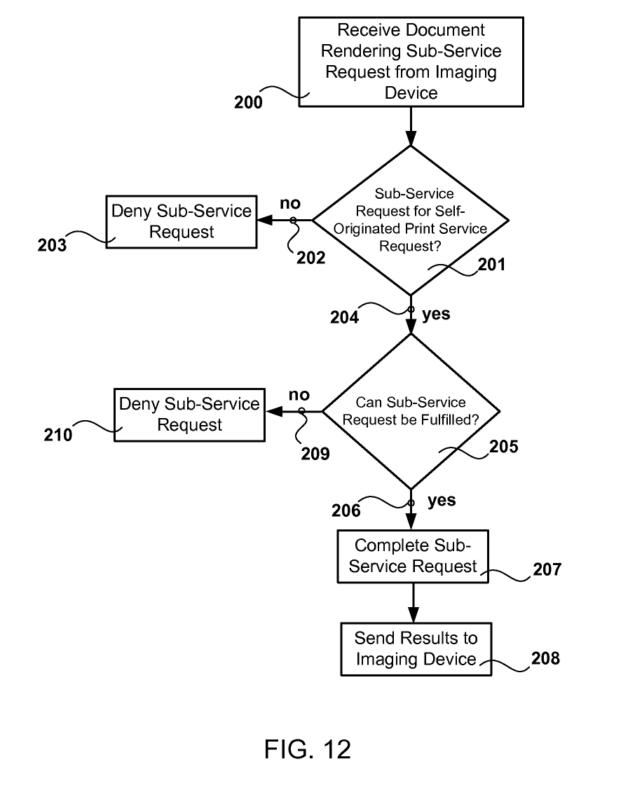

Some embodiments of the present invention may be described in relation to FIG. 12. In these embodiments, a client computing device may receive a document rendering sub-service processing request from an imaging device 200. The client computing device may determine if the request is related to a print service request that originated from the client computing device 201. If the sub-service request is not for a print service request that originated from the client computing device 202, the client computing device may refuse or otherwise deny the sub-service request 203. If the sub-service request is for a print service processing request that originated from the client computing device 204, the client computing device may determine if it can fulfill the request 205. If the client computing device can fulfill the request 206, the client computing device may complete the sub-service request 207, sending the results to the imaging device 208. If the sub-service request cannot be completed 209 by the client computing device, the client computing device may refuse or otherwise deny the sub-service request 210.

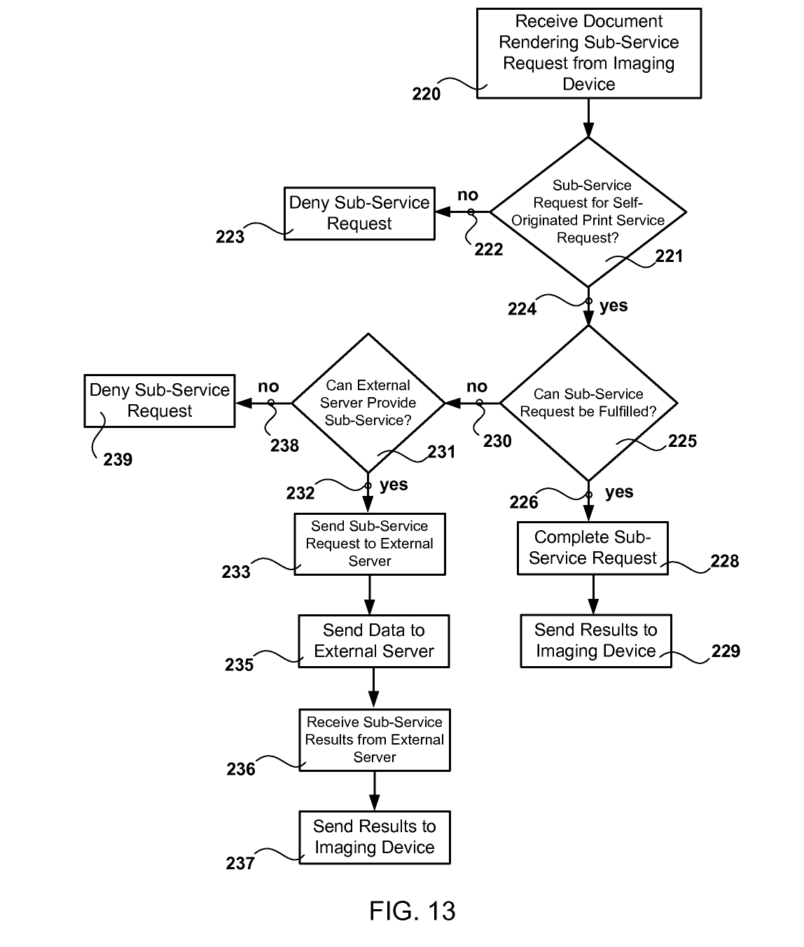

Some embodiments of the present invention may be described in relation to FIG. 13. In these embodiments, a client computing device may receive a document rendering sub-service processing request from an imaging device 220. The client computing device may determine if the request is related to a print service request that originated from the client computing device 221. If the sub-service request is not for a print service request that originated from the client computing device 222, the client computing device may refuse or otherwise deny the sub-service request 223. If the sub-service request is for a print service request that originated from the client computing device 224, the client computing device may determine if it can fulfill the document rendering sub-service request 225. If the client computing device can fulfill the print service request 226, the client computing device may complete the sub-service request 228, and the client computing device may send the results to the imaging device 229. If the sub-service request cannot be fulfilled 230 by the client computing device, the client computing device may determine if an external server can provide the sub-service 231. If the client computing device cannot locate or otherwise determine an external server capable of providing the requested sub-service 238, the client computing device may refuse or otherwise deny the sub-service request 239. If the client computing device can locate or otherwise determine an external server capable of providing the requested sub-service 232, the client computing device may send a sub-service request to the external server 233. The client computing device may send the data required for sub-service to the external server 235. The client computing device may receive the sub-service results from the external server 236, and the client computing device then may send the results to the imaging device 237. In some embodiments described by FIG. 13, the data on which the sub-service operates may be pulled from the imaging device. In alternative embodiments, the data may be accessed directly on the client computing device.

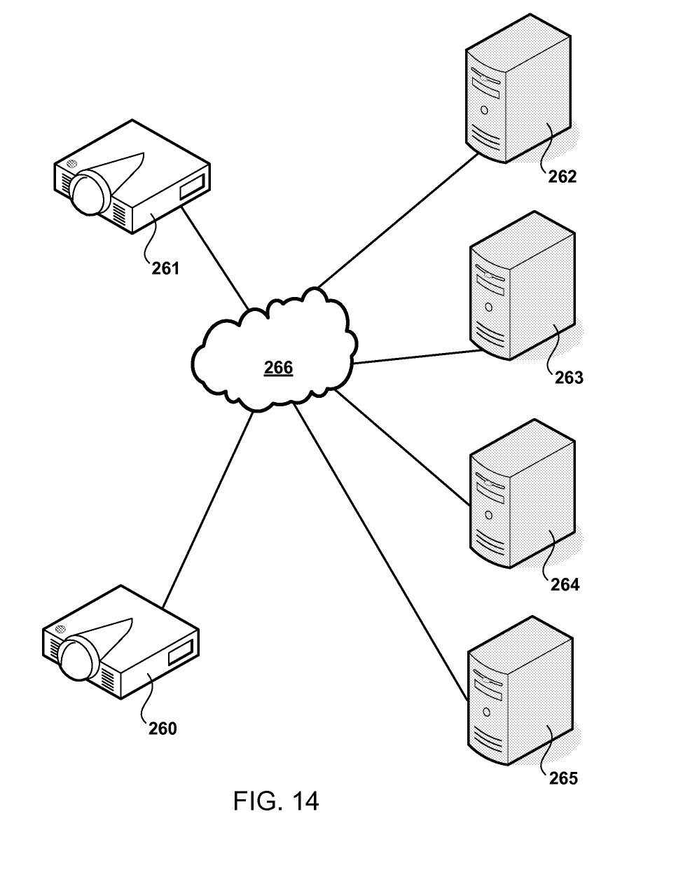

Exemplary embodiments of the present invention may be described in relation to FIG. 14. These exemplary embodiments may comprise one or more display devices (two shown) 260, 261 A display device 260, 161 may be connected to one or more (two shown) client computing devices 262, 263 and one or more (two shown) external hosts or servers 264, 265. In some embodiments, a client computing device 262, 263 and a server 264, 265 may be distinct. In alternate embodiments, a client computing device 262, 263 and a server 264, 265 may be the same device.

In some embodiments of the present invention, the connection between a display device 260, 261 and a client computing device 262, 263 may be via a local port, for example, a USB (Universal Serial Bus) port, a serial port, a parallel port, and a SCSI (Small Computer System Interface). In alternate embodiments, the connection may be a network 266 connection using, for example, TCP/IP (Transmission Control Protocol/Internet Protocol) and AppleTalk. In alternate embodiments, the connection may be wireless connection using, for example, Wi-Fi® (Wireless Fidelity ®), Bluetooth®, and IRDA (Infrared Data Association).

In some embodiments of the present invention, the connection between a display device 260, 261 and a server 264, 265 may be via a local port, for example, a USB (Universal Serial Bus) port, a serial port, a parallel port, and a SCSI (Small Computer System Interface). In alternate embodiments, the connection may be a network 266 connection using, for example, TCP/IP (Transmission Control Protocol/Internet Protocol) and AppleTalk. In alternate embodiments, the connection may be wireless connection using, for example, Wi-Fi® (Wireless Fidelity ®), Bluetooth®, and IRDA (Infrared Data Association).

A display device 260, 261 may be capable of output operations of which exemplary output operations include audio/video (A/V) recording and playback.

In some embodiments of the present invention, a display device 260, 261 may advertise one or more of its output capabilities as a web service. In some embodiments of the present invention, a client computing device 262, 263 may advertise web services. Exemplary services that a client computing device 262, 263 may advertise include one or more web services related to A/V format conversion, A/V encoding/decoding/transcoding, and data encryption/decryption. In some embodiments of the present invention, a server 264, 265 may advertise web services. Exemplary server-based services may include one or more web services related to A/V format conversion, A/V encoding/decoding/transcoding, and data encryption/decryption.

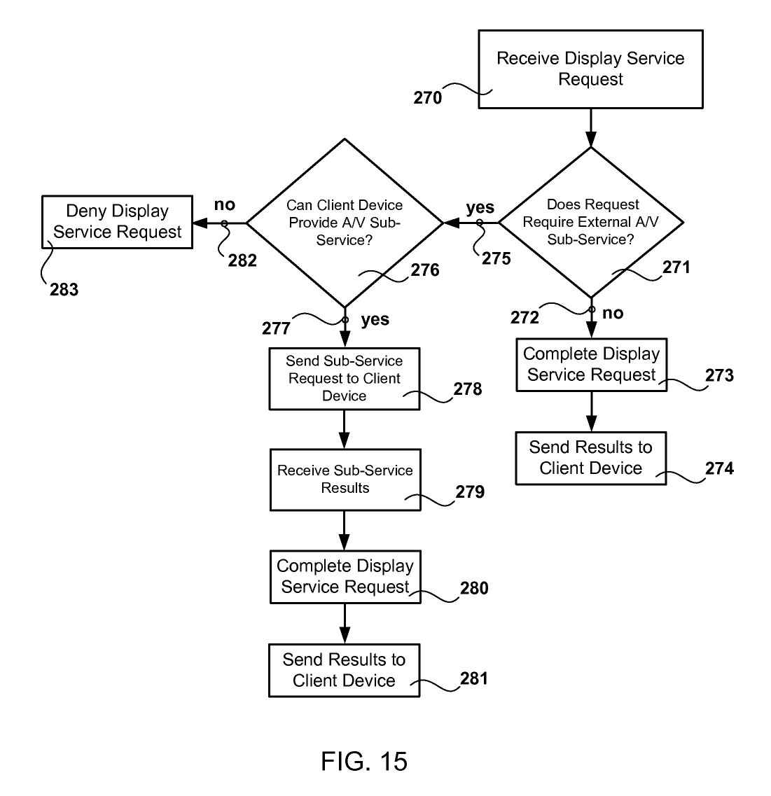

In some exemplary embodiments described in relation to FIG. 15, a client computing device may originate a display service request for a multi-media file to the advertised display web service of a display device. Upon receipt of the display service request 270, the display device may determine if the display service request can be wholly completed internally within the display device 271. One exemplary element of this determination may be a determination of whether or not the display device can provide the display service for input in the input format sent by the client computing device. If the display device can complete the display service request without external services 272, the display device may complete the display service request 273, generating displayable data and sending service results to the client computing device 274. If the display device determines that it cannot wholly complete the display service request 275, for example, if the display device cannot handle the display service request for input of the format sent by the client computing device, the display device may attempt to determine if the originating client computing device can provide the format conversion sub-service required to complete the display service request 276. If the client computing device can provide the format conversion sub-service 277, then the display device may make a sub-service request of the client computing device 278 for the format conversion sub-service. The client computing device may provide the format conversion sub-service and return the converted data to the display device. The display device may receive the sub-service results 279, and the display device may then use the sub-service results (the converted data) to complete the service request 280 of the originating client computing device and return notification of the completed service and any appropriate results to the originating client computing device 281. If the display device determines that the client computing device cannot provide the requisite sub-service 282, the display device may refuse or otherwise deny the display service request 283.

In some embodiments of these exemplary embodiments of the present invention, the format conversion sub-service (or other sub-service) provided by the client computing device may be a public service available to any device. In alternate embodiments, the format conversion sub-service (or other sub-service) provided by the client computing device may be available to a limited group of devices. In yet alternate embodiments, the format conversion sub-service (or other sub-service) provided by the client computing device may be a protected service that may only be available to fulfill a service request that originated from the client computing device. In yet alternate embodiments, the format conversion sub-service (or other sub-service) provided by the client computing device may be a private service that may only be available to fulfill a service request from within the client computing device. In these yet alternative embodiments, the client computing device, upon receipt of a request for a format conversion sub-service (or other sub-service), may ascertain if the sub-service request is a request generated in order to fulfill a service request originated by the client computing device.

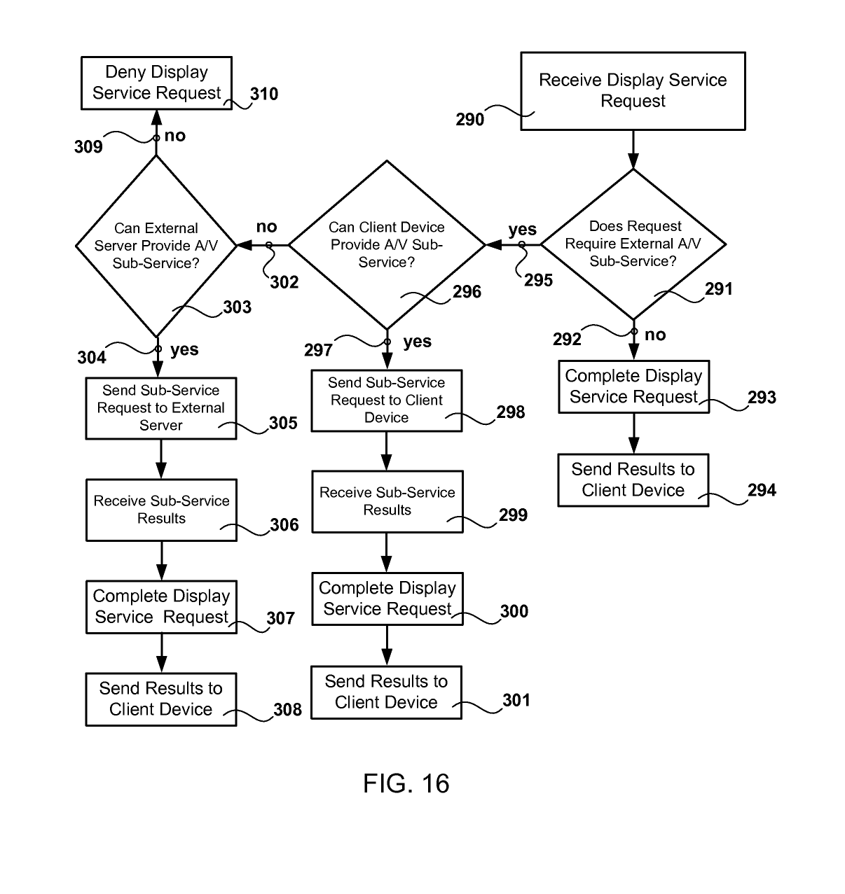

Alternate embodiments of the present invention may be described in relation to FIG. 16. A display service request may be received 290 at a display device from a client computing device. The display device may determine if an external sub-service is required in order to process the display service request 291. If the display device can wholly complete the display service request 292, then the display device may process and complete the request 293 and send the results to the client computing device 294. If the display device does not have all of the requisite services and applications (e.g., format conversion applications, decoding applications, decryption applications) to complete the client computing device display service request 295, then the display device may determine if the client computing device can provide a sub-service required to complete the display service request 296. If the client computing device can provide a requisite sub-service 297, then the display device may send a sub-service request to the client computing device 298. The display device may then receive the sub-service results from the client computing device 299. The display device may then complete the display service request 300 and send the results to the client computing device 301. If the display device determines that the client computing device cannot provide a requisite sub-service 302, then the display device may determine if an external server can provide a sub-service required to complete the display service request 303. If the external server can provide the sub-service 304, then the display device may send a sub-service request to the external server 305. The display device may receive the sub-service results from the external server 306, and then the display device may complete the display service request 307. Upon completion of the display service request, the display device may send the results to the client computing device 308. If the display device determines that an external server cannot provide the sub-service 309, then the display device may refuse or otherwise deny the display service request 310.

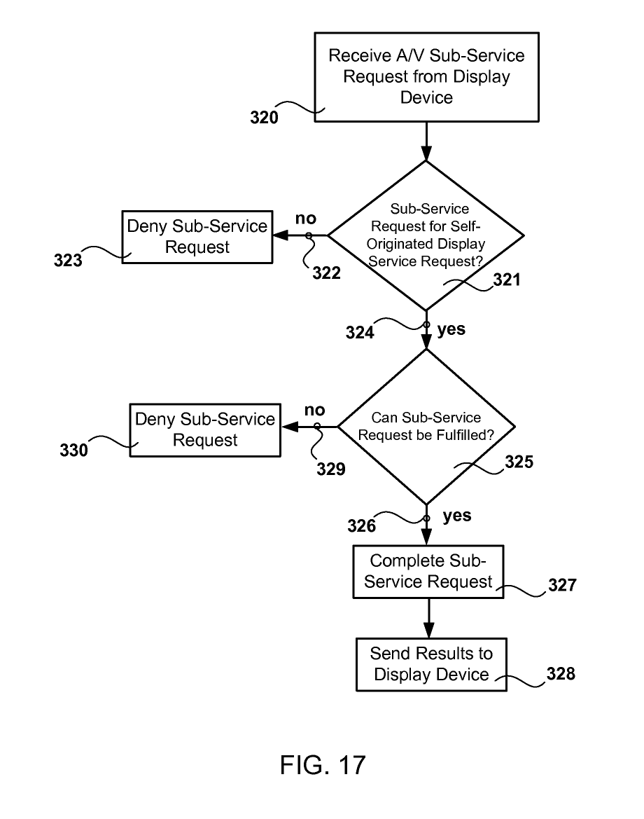

Some embodiments of the present invention may be described in relation to FIG. 17. In these embodiments, a client computing device may receive an A/V sub-service processing request from a display device 320. The client computing device may determine if the request is related to a display service request that originated from the client computing device 321. If the sub-service request is not for a display service request that originated from the client computing device 322, the client computing device may refuse or otherwise deny the sub-service request 323. If the sub-service request is for a display service processing request that originated from the client computing device 324, the client computing device may determine if it can fulfill the request 325. If the client computing device can fulfill the request 326, the client computing device may complete the sub-service request 327, sending the results to the display device 328. If the sub-service request cannot be completed 329 by the client computing device, the client computing device may refuse or otherwise deny the sub-service request 330.

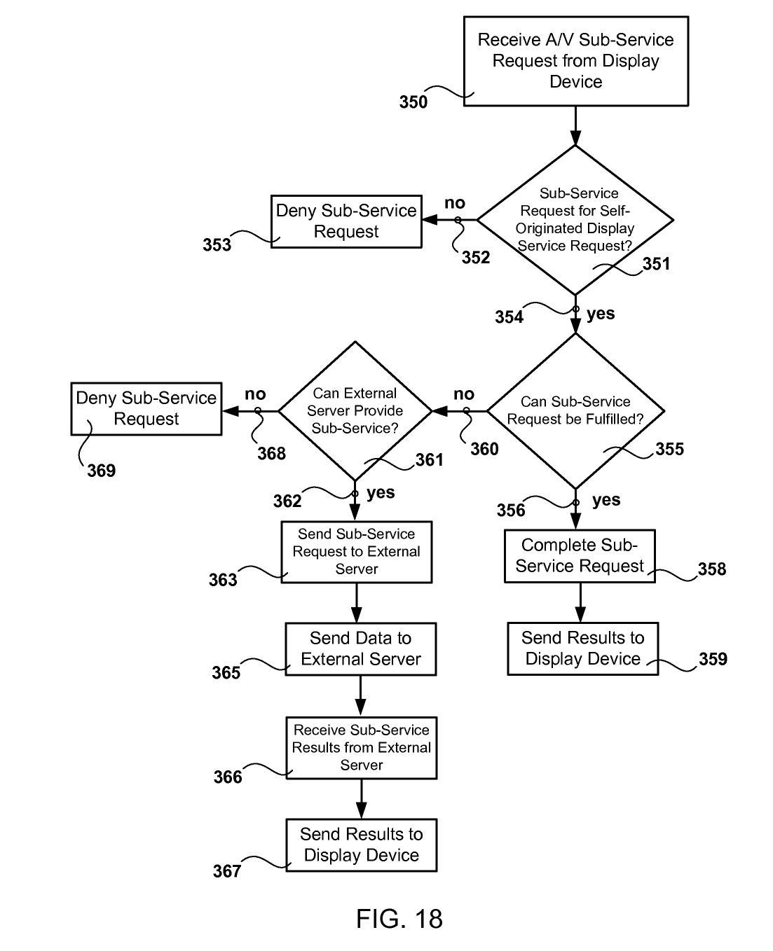

Some embodiments of the present invention may be described in relation to FIG. 18. In these embodiments, a client computing device may receive an A/V sub-service processing request from a display device 350. The client computing device may determine if the request is related to a display service request that originated from the client computing device 351. If the sub-service request is not for a display service request that originated from the client computing device 352, the client computing device may refuse or otherwise deny the sub-service request 353. If the sub-service request is for a display service request that originated from the client computing device 354, the client computing device may determine if it can fulfill the A/V sub-service request 355. If the client computing device can fulfill the A/V sub-service request 356, the client computing device may complete the sub-service request 358, and the client computing device may send the results to the display device 359. If the sub-service request cannot be fulfilled 360 by the client computing device, the client computing device may determine if an external server can provide the sub-service 361. If the client computing device cannot locate or otherwise determine an external server capable of providing the requested sub-service 368, the client computing device may refuse or otherwise deny the sub-service request 369. If the client computing device can locate or otherwise determine an external server capable of providing the requested sub-service 362, the client computing device may send a sub-service request to the external server 363. The client computing device may send the data required for sub-service to the external server 365. The client computing device may receive the sub-service results from the external server 366, and the client computing device then may send the results to the display device 367. In some embodiments described by FIG. 18, the data on which the sub-service operates may be pulled from the display device. In alternative embodiments, the data may be accessed directly on the client computing device.

In some embodiments of the present invention, a charge may be incurred by a device requesting a sub-service. In some embodiments, a peripheral device may incur a charge from a client computing device if the client computing device provides a sub-service to the peripheral device. In some embodiments, a peripheral device may not incur a charge from a client computing device if the sub-service provided is related to a service request that the client computing device originated. In some embodiments, a peripheral device may incur a charge from an external server if the external server provides a sub-service to the peripheral device. In some embodiments, a client computing device may incur a charge from an external server if the external server provides a sub-service to the client computing device. In some embodiments, a charge incurred by a peripheral device in the servicing of a request from a client computing device may be passed to the client computing device. In some embodiments, a charge incurred by a client computing device in the servicing of a sub-service request from a peripheral device may be passed to the peripheral device.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for providing a peripheral device service, said method comprising:
a) receiving a service request at a peripheral device from a client computing device;
b) determining said service request requires at least one sub-service, wherein said at least one sub-service is unavailable on said peripheral device;
c) determining the availability of said at least one sub-service on said client computing device; and
d) if said at least one sub-service is available on said client computing device:
i) sending a sub-service request to said client computing device for said at least one sub-service;
ii) receiving from said client computing device results for said at least one sub-service; and
iii) completing said service request using said results for said at least one sub-service, thereby producing completion results.

2. A method as described in claim 1 further comprising sending said completion results from said peripheral device to said client computing device.

3. A method as described in claim 1 further comprising:
a) if said at least one sub-service is not available on said client computing device:
i) determining the availability of said at least one sub-service on an external server; and
ii) if said at least one sub-service is available on said external server:
(1) sending a sub-service request to said external server for said at least one sub-service;
(2) receiving from said external server results for said at least one sub-service; and
(3) completing said service request using said results for said at least one sub-service.

4. A method as described in claim 1, wherein said service request is a web service request.

5. A method as described in claim 1, wherein said peripheral device is an imaging device.

6. A method as described in claim 1, wherein said at least one sub-service is a document rendering application.

7. A method as described in claim 6, wherein said document rendering application is a document format conversion application or a natural language translation application.

8. A method as described in claim 1 further comprising pulling document data from said client computing device.

9. A method as described in claim 1 further comprising:
a) if said at least one sub-service is available on said client computing device:
i) sending document data from said peripheral device to said client computing device.

10. A method as described in claim 1 further comprising using document data resident on said client computing device if said at least one sub-service is available on said client computing device.

11. A method for providing a peripheral device service, said method comprising:
a) sending a service request from a client computing device to a peripheral device;
b) receiving a sub-service request at said client computing device from said peripheral device, wherein said sub-service request is associated with an originating service request from an originating device;
c) determining a sub-service availability condition for said peripheral device at said client computing device;
d) processing said sub-service request based on said sub-service availability condition; and
e) sending the results of said processing to said peripheral device from said client computing device.

12. A method as described in claim 11, wherein said service request is a web service request.

13. A method as described in claim 11, wherein said peripheral device is an imaging device.

14. A method as described in claim 11, wherein said sub-service is a document rendering application.

15. A method as described in claim 11, wherein said sub-service is a document format conversion application or a natural language translation application.

16. A method as described in claim 11, wherein said determining the availability of said sub-service on said client computing device comprises:
a) comparing said originating device and said client computing device;
b) indicating said sub-service on said client computing device is unavailable if said originating device is not said client computing device; and
c) indicating said sub-service on said client computing device is available if said originating device is said client computing device.

17. A method as described in claim 11, wherein said determining the availability of said sub-service on said client computing device comprises:
a) comparing said originating device and said client computing device;
b) indicating said sub-service on said client computing device is available for a first cost if said originating device is not said client computing device; and
c) indicating said sub-service on said client computing device is available for a second cost if said originating device is said client computing device.

18. A method as described in claim 17, wherein said first cost is greater than said second cost.

19. A method as described in claim 17, wherein said second cost is zero.

20. A method as described in claim 11 further comprising denying said sub-service request if said sub-service is not available on said client computing device.

21. A method as described in claim 11 further comprising:
a) if said sub-service is not available on said client computing device:
i) determining the availability of said sub-service on an external server; and
ii) if said sub-service is available on said external server:
(1) sending a sub-service request to said external server for said sub-service;
(2) receiving from said external server results for said sub-service; and
(3) sending said results for said sub-service to said peripheral device.

22. A method for providing a print service, said method comprising:
a) receiving a print service request at an imaging device from a client computing device;
b) determining said print service request requires at least one sub-service, wherein said at least one sub-service is unavailable on said imaging device;
c) determining the availability of said at least one sub-service on said client computing device; and
d) if said at least one sub-service is available on said client computing device:
i) sending a sub-service request to said client computing device for said at least one sub-service;
ii) receiving from said client computing device results for said at least one sub-service; and
iii) completing said print service request using said results for said at least one sub-service.

23. A method as described in claim 22, wherein said at least one sub-service is a document rendering application.

24. A method as described in claim 22, wherein said at least one sub-service is a document format conversion application or a natural language translation application.

25. A method as described in claim 22 further comprising:
a) if said at least one sub-service is not available on said client computing device:
i) determining the availability of said at least one sub-service on an external server; and
ii) if said at least one sub-service is available on said external server:
(1) sending a sub-service request to said external server for said at least one sub-service;
(2) receiving from said external server results for said at least one sub-service; and
(3) completing said print service request using said results for said at least one sub-service.
